(19) United States
(12) Patent Application Publication
(10) Pub. No.: US 2023/0307778 A1
(43) Pub. Date: Sep. 28, 2023

(54) TRACTION BATTERY PACK ASSEMBLING METHOD

(71) Applicant: Ford Global Technologies, LLC, Dearborn, MI (US)

(72) Inventors: Patrick Daniel Maguire, Ann Arbor, MI (US); Jason C. Marcath, Dearborn, MI (US); Marc Dugas, Wixom, MI (US); Nilesh Patil, Kolhapur (IN)

(21) Appl. No.: 17/844,329

(22) Filed: Jun. 20, 2022

Related U.S. Application Data
(60) Provisional application No. 63/322,766, filed on Mar. 23, 2022.

(51) Int. Cl. H01M 50/293; H01M 50/209; H01M 50/249

(52) U.S. Cl. CPC H01M 50/293; H01M 50/209; H01M 50/249; H01M 2220/20

(57) ABSTRACT

A battery pack assembly method, including: positioning at least one cell stack within an enclosure structure; moving a compressing wall against the at least one cell stack to a position where the compressing wall applies a compressive force to the at least one cell stack between the enclosure structure and the compressing wall; and securing the compressing wall to hold the at least one cell stack in the position.

### CROSS-REFERENCE TO RELATED APPLICATIONS

This application claims priority to U.S. Provisional Application No. 63/322,766, which was filed on 23 Mar. 2022 and is incorporated herein by reference

### TECHNICAL FIELD

This disclosure relates generally to compressing battery cells of a traction battery pack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. The traction battery pack assembly of an electrified vehicle can include groups of battery cells.

### SUMMARY

In some aspects, the techniques described herein relate to a battery pack assembly method, including: positioning at least one cell stack within an enclosure structure; moving a compressing wall against the at least one cell stack to a position where the compressing wall applies a compressive force to the at least one cell stack between the enclosure structure and the compressing wall; and securing the compressing wall to hold the at least one cell stack in the position.

In some aspects, the techniques described herein relate to a method, wherein the at least one cell stack includes a first cell stack and a second cell stack that is alongside the first cell stack.

In some aspects, the techniques described herein relate to a method, wherein the enclosure structure circumferentially surrounds the first cell stack and the second cell stack after the positioning.

In some aspects, the techniques described herein relate to a method, wherein the first cell stack and the second cell stack are spaced from each other during the moving and during the securing.

In some aspects, the techniques described herein relate to a method, wherein the at least one cell stack includes a group of cells disposed along an axis, wherein the compressive force is applied along the axis.

In some aspects, the techniques described herein relate to a method, wherein the enclosure structure is an enclosure tray.

In some aspects, the techniques described herein relate to a method, further including, after the positioning, securing an enclosure cover to the enclosure tray.

In some aspects, the techniques described herein relate to a method, further including securing the compressing wall by welding the compressing wall to the enclosure structure.

In some aspects, the techniques described herein relate to a method, further including distributing cells of the at least one cell stack along an axis.

In some aspects, the techniques described herein relate to a method, wherein the at least one cell stack includes plurality of separator plates that each include a frame about a compressible material, the compressible material configured to permit expansion of the battery cells within the at least one cell stack.

In some aspects, the techniques described herein relate to a method, wherein the plurality of separator plates include a plurality of first separator plates and a plurality of second separator plates, each of the first separator plates disposed axially between battery cells of the at least one cell stack, each of the first separator plates having the compressible material exposed on a first axial side and exposed on an opposite, second axial side, each of the second separator plates disposed at opposing axial ends of the at least one cell stack, each of the second separator plates having the compressible material exposed on a first axial side that faces the battery cells of the at least one cell stack and unexposed on an opposite, second axial side that faces away from the battery cells of the at least one cell stack.

In some aspects, the techniques described herein relate to a method, wherein the second axial sides of the second separator plates interface directly with the enclosure structure, or with the compressing wall.

In some aspects, the techniques described herein relate to a method, further including dividing an interior of the enclosure structure into different areas using the compressing wall, the at least one cell stack disposed in one area on a first side of the compressing wall, a Battery Energy Control Module disposed on an opposite, second side of the compressing wall.

In some aspects, the techniques described herein relate to a traction battery pack assembly, including: an enclosure structure providing an interior area; a compressing wall disposed within the interior area; and at least one cell stack compressed by the enclosure structure and the compressing wall.

In some aspects, the techniques described herein relate to an assembly, wherein the enclosure structure is an enclosure tray.

In some aspects, the techniques described herein relate to an assembly, wherein the at least one cell stack includes a first cell stack alongside a second cell stack, the first cell stack having a group of cells distributed along a first axis, the second cell stack having a group of cells distributed along a different second axis, wherein a compressive force applied by the compressing wall is applied in a directing that is parallel to the first axis and the second axis.

In some aspects, the techniques described herein relate to an assembly, wherein the first axis is perpendicular to the second axis.

In some aspects, the techniques described herein relate to an assembly, further including a plurality of separator plates within the at least one cell stack, the separator plates including a frame about a compressible material, the compressible material configured to permit expansion of the battery cells within the at least one cell stack.

In some aspects, the techniques described herein relate to an assembly, wherein the plurality of separator plates includes a plurality of first separator plates and a plurality of second separator plates of the at least one cell stack, each of the first separator plates disposed axially between battery cells of the at least one cell stack, each of the first separator plates having the compressible material exposed on a first axial side and exposed on an opposite, second axial side, each of the second separator plates disposed at opposing axial ends of the at least one cell stack, each of the second separator plates having the compressible material exposed on a first axial side that faces the battery cells of the at least one cell stack and unexposed on an opposite, second axial side that faces away from the battery cells of the at least one cell stack.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates a partially expanded view of a traction battery pack assembly from the electrified vehicle of FIG. 1 according to an exemplary aspect of the present disclosure.

FIG. 3 illustrates a partially expanded cell stack from the traction battery pack assembly of FIG. 2.

FIG. 4 illustrates a flow of a method of assembling the traction battery pack of FIG. 2 according to an exemplary aspect of the present disclosure.

### DETAILED DESCRIPTION

This disclosure details example traction battery pack assemblies having an enclosure that provides an interior area. Battery cells and electronic modules can be held within the interior area along with other components. The battery cells can be used to power an electric machine.

In particular, this disclosure details an exemplary systems and methods relating to compressing and holding the battery cells.

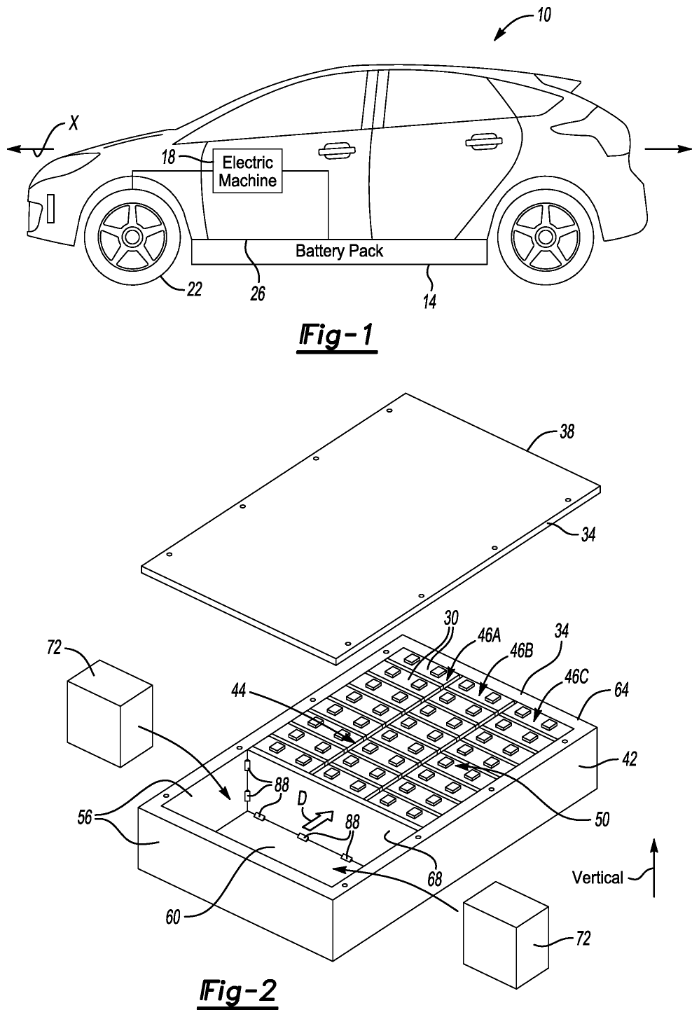

With reference to FIG. 1, an electrified vehicle 10 includes a traction battery pack assembly 14, an electric machine 18, and wheels 22. The traction battery pack assembly 14 powers an electric machine 18, which can convert electrical power to mechanical power to drive the wheels 22. The traction battery pack assembly 14 can be a relatively high-voltage battery.

The traction battery pack assembly 14 is, in the exemplary embodiment, secured to an underbody 26 of the electrified vehicle 10. The traction battery pack assembly 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack. A longitudinal axis X of the vehicle 10 extends from a vehicle front end to a vehicle rear end.

With reference now to FIG. 2, the traction battery pack assembly 14 includes a plurality of battery cells 30 held within an enclosure assembly 34. In the exemplary embodiment, the enclosure assembly 34 comprises various enclosure structures. In particular, the example enclosure assembly 34 includes an enclosure cover 38, and an enclosure floor 60. The enclosure cover 38 and enclosure floor 60 are secured together to provide an interior area 44 that houses and encloses the plurality of battery cells 30. The interior area 44 is sealed.

The plurality of battery cells (or simply, “cells”) 30 are for supplying electrical power to various components of the electrified vehicle 10. The battery cells 30 are stacked side-by-side relative to one another to construct one of a plurality of cell stacks 46A-46C, which are positioned side-by-side to provide a cell matrix 50. In this example, each cell stack 46A-46C includes nine individual battery cells 30 disposed along a respective cell stack axis. The example cell matrix 50 includes three cell stacks 46A-46C. Within the enclosure assembly 34, the cells stacks 46A-46 are spaced slightly away from each other.

Although a specific number of battery cells 30 and cell stacks 46 are illustrated in the various embodiments of this disclosure, the traction battery pack assembly 14 could include any number of cells 30 and cell stacks 46. In some examples, the embodiments can include an even quantity of battery cells 30 and an even quantity of cell stacks 46, which can help to support and efficient electrical bussing arrangement. In other words, this disclosure is not limited to the specific configuration of cells 30 shown in FIG. 2.

In an embodiment, the battery cells 30 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

The enclosure tray 42, in this example, includes a plurality of side walls 56 extending vertically upward from an enclosure floor 60. The side walls 56 can be extruded structures connected together and to the floor via welds or a metal stamping forming a bottom floor with four side walls, for example. Vertical, for purposes of this disclosure, is with reference to ground and a general orientation of the vehicle 10 during operation. The side walls 56 of the tray circumferentially surround the cell stacks 46 of the traction battery pack assembly 14 in this example.

When the traction battery pack assembly 14 is assembled, the enclosure cover 38 can be secured to vertically upper side 64 of the enclosure tray 42. An interface between the enclosure cover 38 and the enclosure tray 42 extends circumferentially continuously about the interior area 44. Mechanical fasteners or welds, for example, can be used to secure the enclosure cover 38 and the enclosure tray 42.

When the traction battery pack assembly 14 is assembled, the cell matrix 50 is positioned within the interior area 44. The traction battery pack assembly 14 includes a compressing wall 68 that is moved during assembly in a direction D and then secured to compress the battery cells 30 of the cell matrix 50. The compressing wall 68 can be an extruded or stamped metal or metal alloy material, for example.

The compressing wall 68 divides the interior area 44 into a first area on one side of the compressing wall 68, and a second area on an opposite, second side of the compressing wall 68. The cell matrix 50 is disposed in the first area. Electronic components 72, such as a Battery Energy Control Module (BECM), can be disposed in the second area.

The traction battery pack assembly 14 can be considered a cell-to-pack battery assembly. Unlike conventional traction battery pack battery assemblies, a cell-to-pack battery assembly incorporates battery cells or other energy storage devices into the enclosure assembly 34 without the cells being arranged in arrays or modules. In a cell-to-pack battery assembly, the enclosure assembly 34 helps to apply compressive forces to the cells. The cell-to-pack battery assembly may therefore eliminate most, if not all, of the array support structures used in conventional battery arrays (e.g., array frames, spacers, rails, endplates, bindings, etc.) that are used to group and hold the battery cells within the arrays/modules.

FIG. 3 illustrates an expanded view of the cell stack 46A. The remaining cell stacks 46B and 46C of the cell matrix 50 are constructed similarly to the cell stack 46A.

The cell stack 46A includes a group of cells 30 distributed along a cell stack axis A. First separator plates 72A are disposed between each of the cells 30 along the cell stack axis A. The separator plates 72A can include a frame portion 74A that holds a compressible material 76A. The compressible material 76A can compress to permit some expansion of the cells 30. The compressible material 76A can be foam.

Second separator plates 72B are disposed at opposing axial ends of the cells 30 within the cell stack 46A. The second separator plates 72B include a frame portion 74B that holds a compressible material 76B. The compressible material 76B can be foam. The compressible material 76B can compress to permit some expansion of the cells 30.

The separator plates 72A differ from the separator plates 72B in this example because the separator plates 72A include exposed compressible material 76A on opposing axial sides of the separator plates 72A. The separator plates 72B included compressible material 76B that is exposed on an axial side of the separator plate 72B that faces the battery cells 30, but is unexposed on the opposite axial side that faces away from the battery cells 30 and interfaces directly with the enclosure tray 42 or the compressing wall 68.

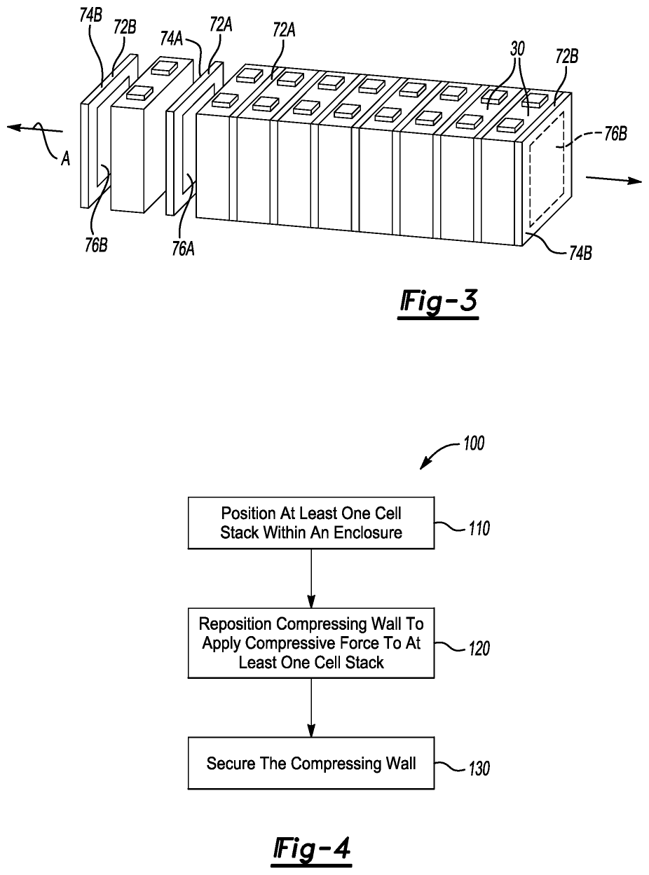

An example method 100 of assembling the traction battery pack assembly 14 will now be explained with reference to FIG. 4 and continued reference to FIGS. 1-3. The method 100 begins at a step 110 wherein at least one cell stack is positioned within an enclosure structure. In this example, the three cell stacks 46A-46C are positioned within the enclosure tray 42. When positioning the cell stacks 46A-46C, the compressing wall 68 is not secured to the enclosure tray 42.

Next, at a step 120 the compressing wall 68 is repositioned and moved in the direction D against the cell stacks 46A-46C. This compresses the battery cells 30 of the cell stacks 46A-46C along the respective axis of the cell stack 46A-46C.

A tool, such as a pneumatically driven actuator, can be used to move the compressing wall 68 against the cell stacks 46A-46C. Other devices to move the compressing wall 68 could be used in other examples.

The compressing wall 68 can be moved in the direction D until the compressing wall 68 is in a position where the compressing wall applies a desired compressive force to the cell stacks 46A-46C. At a step 130, the method 100 secures the compressing wall 68 in the position where the compressing wall 68 applies the desired force.

In this example, welds 88 are used to secure the compressing wall 68 to the enclosure tray 42. The securing could instead or additionally involve using mechanical fasteners or adhesive bonding to secure the compressing wall 68 to the enclosure tray 42.

After the compressing wall 68 is secured, the tool that moves the compressing wall 68 can be removed. Each of the cell stacks 46A-46C is then compressed along the respective cell stack axis A between the compressing wall 68 and the side wall 56 of the enclosure tray 42.

In this example, the axes of the cell stacks 46A-46C are parallel to the axis X of the vehicle 10 when the traction battery pack assembly 14 is installed with the vehicle 10. In another example, the axis of the cell stacks 46A-46C could be perpendicular to the axis X of the vehicle 10.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly method, comprising:
positioning at least one cell stack within an enclosure structure;
moving a compressing wall against the at least one cell stack to a position where the compressing wall applies a compressive force to the at least one cell stack between the enclosure structure and the compressing wall; and
securing the compressing wall to hold the at least one cell stack in the position.

2. The method of claim 1, wherein the at least one cell stack includes a first cell stack and a second cell stack that is alongside the first cell stack.

3. The method of claim 2, wherein the enclosure structure circumferentially surrounds the first cell stack and the second cell stack after the positioning.

4. The method of claim 3, wherein the first cell stack and the second cell stack are spaced from each other during the moving and during the securing.

5. The method of claim 1, wherein the at least one cell stack includes a group of cells disposed along an axis, wherein the compressive force is applied along the axis.

6. The method of claim 3, wherein the enclosure structure is an enclosure tray.

7. The method of claim 6, further comprising, after the positioning, securing an enclosure cover to the enclosure tray.

8. The method of claim 1, further comprising securing the compressing wall by welding the compressing wall to the enclosure structure.

9. The method of claim 1, further comprising distributing cells of the at least one cell stack along an axis.

10. The method of claim 9, wherein the at least one cell stack includes plurality of separator plates that each include a frame about a compressible material, the compressible material configured to permit expansion of the battery cells within the at least one cell stack.

11. The method of claim 10, wherein the plurality of separator plates include a plurality of first separator plates and a plurality of second separator plates,
each of the first separator plates disposed axially between battery cells of the at least one cell stack, each of the first separator plates having the compressible material exposed on a first axial side and exposed on an opposite, second axial side,
each of the second separator plates disposed at opposing axial ends of the at least one cell stack, each of the second separator plates having the compressible material exposed on a first axial side that faces the battery cells of the at least one cell stack and unexposed on an opposite, second axial side that faces away from the battery cells of the at least one cell stack.

12. The method of claim 11, wherein the second axial sides of the second separator plates interface directly with the enclosure structure, or with the compressing wall.

13. The method of claim 10, further comprising dividing an interior of the enclosure structure into different areas using the compressing wall, the at least one cell stack disposed in one area on a first side of the compressing wall, a Battery Energy Control Module disposed on an opposite, second side of the compressing wall.

14. A traction battery pack assembly, comprising:
an enclosure structure providing an interior area;
a compressing wall disposed within the interior area; and
at least one cell stack compressed by the enclosure structure and the compressing wall.

15. The assembly of claim 14, wherein the enclosure structure is an enclosure tray.

16. The assembly of claim 14, wherein the at least one cell stack includes a first cell stack alongside a second cell stack, the first cell stack having a group of cells distributed along a first axis, the second cell stack having a group of cells distributed along a different second axis, wherein a compressive force applied by the compressing wall is applied in a directing that is parallel to the first axis and the second axis.

17. The assembly of claim 16, wherein the first axis is perpendicular to the second axis.

18. The assembly of claim 14, further comprising a plurality of separator plates within the at least one cell stack, the separator plates including a frame about a compressible material, the compressible material configured to permit expansion of the battery cells within the at least one cell stack.

19. The assembly of claim 18, wherein the plurality of separator plates includes a plurality of first separator plates and a plurality of second separator plates of the at least one cell stack,
each of the first separator plates disposed axially between battery cells of the at least one cell stack, each of the first separator plates having the compressible material exposed on a first axial side and exposed on an opposite, second axial side,
each of the second separator plates disposed at opposing axial ends of the at least one cell stack, each of the second separator plates having the compressible material exposed on a first axial side that faces the battery cells of the at least one cell stack and unexposed on an opposite, second axial side that faces away from the battery cells of the at least one cell stack.
